(19) United States
(12) Patent Application Publication
(10) Pub. No.: US 2004/0094750 A1
(43) Pub. Date: May 20, 2004

(54) Highly filled composite containing resin and filler

(76) Inventors: Soemantri Widagdo, St. Paul, MN (US); Paul D. Driscoll, Woodbury, MN (US); Bridget A. Bentz, Brooklyn Park, MN (US); Mary R. Boone, West Saint Paul, MN (US)

Correspondence Address: 3M INNOVATIVE PROPERTIES COMPANY, PO BOX 33427, ST. PAUL, MN, 55133-3427, US

(21) Appl. No.: 10/299,144

(22) Filed: Nov. 19, 2002

(51) Int. Cl. H01C 1/00

(52) U.S. Cl. 252/500

(57) ABSTRACT

A highly filled composite is formed by extruding through a multiple screw extruder a thermoplastic resin and sufficient filler so that an autogranulating extrudate exits the extruder barrel. The extruder is operated without an exit manifold, strand die or breaker plate. The extrudate forms irregularly shaped granules. The granules provide a molding composition that can be used to form highly filled molded articles such as fuel cell separator plates and end plates by compression, injection or compression-injection molding.

### FIELD OF THE INVENTION

This invention relates to highly filled composites and to methods for their preparation.

### BACKGROUND

Fuel cells typically are constructed using end plates and separator plates made from highly filled composites containing thermoplastic resin and conductive fillers. References describing such composites include U.S. Pat. Nos. 5,798,188, 6,083,641, 6,180,275, 6,251,978 and 6,261,495; U.S. patent application Ser. No. 2002/0039675 A1; European Pat. Application No. EP 1 059 348 A1; Japanese Patent Application Nos. 8-1663, 2000-200142, 2000-348739 and 2001-122677; Taiwan Patent Application No. 434930 and PCT Patent Application Nos. WO 97/50138, WO 97/50139, WO 00/30202, WO 00/30203, WO 00/44005 and WO 01/89013.

### SUMMARY OF THE INVENTION

Many researchers have sought molding compositions that could be used for compression or injection molding of fuel cell separator plates and other conductive components. For example, in some of the above-mentioned references pellets of a highly filled composite are formed by combining thermoplastic resin and conductive filler in an extruder, converting the output from the extruder into pellets using a pelletizer, and feeding the thus-formed pellets to a suitable molding apparatus. The pellets typically have fairly regular shapes, e.g., cylinders. Less highly filled pellets containing thermoplastic resin and conductive filler are also commercially available, e.g., VECTRA™ A230 carbon-fiber reinforced liquid crystal polymer, commercially available from the Ticona Division of Celanese AG. Japanese Patent Application No. 8-1663 reports preparation of flake-form pellets using an extruder operated without a die and breaker plate. U.S. patent application Ser. No. 2002/0039675 A1 reports preparation of pellets that may be mixed with finer particles and preferably are separated therefrom.

We have found that a particularly useful molding composition can be formed by combining thermoplastic resin and filler (e.g., conductive filler) in a multiple screw extruder operated without an exit manifold (a so-called “8-0” adapter), die, breaker plate or pelletizer. The resulting extrudate is “autogranulating” or will “autogranulate”, that is, the extrudate will exit the extruder barrel as irregularly shaped granules without requiring pelletization, chopping, pulverization, crushing or other comminution techniques for forming pellets or other shaped particles. An autogranulating extrudate does not have to be pelletized, and in preferred embodiments is sufficiently highly loaded that it can not readily be pelletized. The extrudate does not have to be classified by separation and removal of finer particles, and in preferred embodiments is not so classified. The extrudate can be used in its as-extruded autogranulated form as a thermoplastic composite for molding shaped articles. Thus the present invention provides, in one aspect, a process for forming thermoplastic composite granules comprising extruding through a multiple screw extruder:

a) thermoplastic resin; and

b) sufficient filler so that an autogranulating extrudate exits the extruder barrel.

In another aspect, the invention provides an autogranulating thermoplastic composite comprising a blend of irregularly shaped granules containing thermoplastic resin and filler.

Preferred embodiments of the thermoplastic composite granules can be used as a molding compound for forming highly filled articles (e.g., fuel cell separator plates and end plates) by compression molding, injection molding or compression-injection molding.

### BRIEF DESCRIPTION OF THE DRAWING

FIG. 1 is an exploded perspective view of a typical fuel cell.

FIG. 2 is an exploded perspective view of the exit end of a typical twin screw extruder.

FIG. 3 is a perspective view of a modified twin screw extruder for use in carrying out the method of the invention.

FIG. 4 is a graph showing particle size ranges for the conductive composite of Example 2.

### DETAILED DESCRIPTION

In the practice of the present invention, “irregularly shaped” granules are granules the majority of which do not have the regular cylindrical shapes characteristically found in a pelletized extruded thermoplastic.

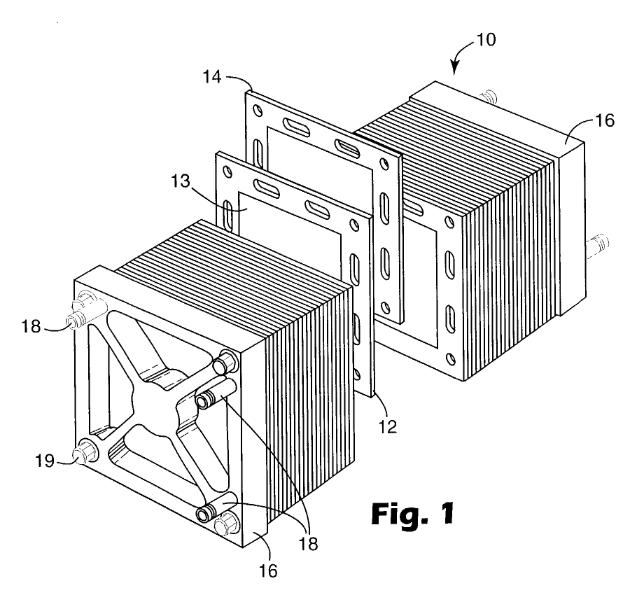

FIG. 1 is an exploded perspective view of a typical fuel cell 10 assembled from a series of polymer electrolyte membranes 12 sandwiched between pairs of gas diffusion electrodes 13, and interspersed between bipolar gas separation plates 14 that serve as current collectors. End plates 16 equipped with fluid conduits 18 and hold-down fasteners 19 clamp the membranes 12 and separation plates 14 together in a stack. Separation plates 14 and end plates 16 preferably are molded from thermoplastic composite granules of the invention.

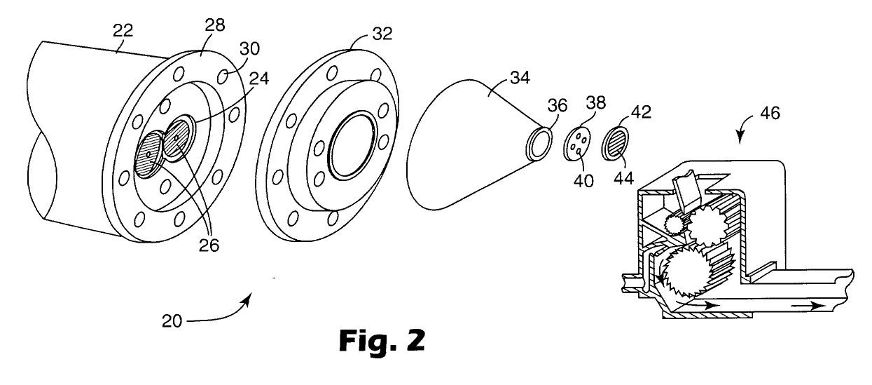

FIG. 2 is an exploded perspective view of the exit end of a typical twin screw extruder 20. Barrel 22 has a figure eight-shaped bore 24 containing two co-rotating, fully intermeshing extruder screws 26. Exit face 28 on barrel 22 is equipped with holes 30 which normally house fasteners (not shown in FIG. 2) that clamp a two-part exit manifold made from 8-0 adapter base 32 and 8-0 adapter 34 to exit face 28. A converging chamber within 8-0 adapter 34 converts the twin extrudate streams exiting figure 8-shaped bore 24 into a single extrudate stream which normally passes through outlet 36. The extrudate normally passes through extrusion die 38 equipped with one or more strand orifices 40 and then through breaker plate 42 equipped with vanes 44 or other suitable orifices which may be used to further mix the extrudate. The extrudate is then pelletized by a suitable device such as pelletizer 46.

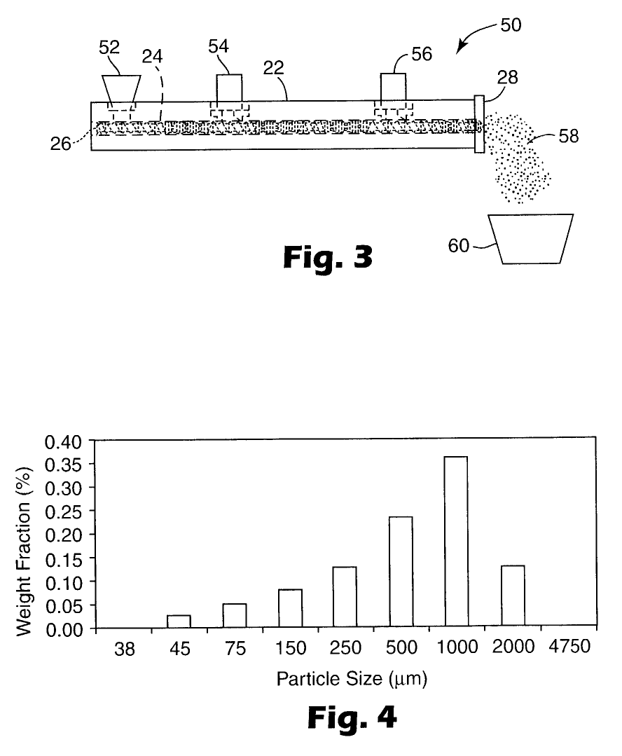

FIG. 3 is a side view of a modified twin screw extruder for use in carrying out the method of the invention. Extruder 50 employs barrel 22 and twin screws 26 (one of which is shown using hidden lines in bore 24) from FIG. 2, but 8-0 adapter base 32, 8-0 adapter 34, die 38 and breaker plate 42 have been removed. These components increase back pressure in the extruder, and can inhibit the attainment of high filler loading levels. When these components are removed, higher filler amounts can be added during extrusion.

A thermoplastic resin can be added to extruder 50 at input end main feed port 52, and filler can be added to extruder 50 at one or more locations along the length of barrel 22 such as feed ports 54 and 56. Provided that sufficient filler is added to the extruder (e.g., an amount of about 40 wt. % or more based on the total weight of the extrudate), an autogranulating extrudate can form granules 58 as it exits extruder 50, and can be collected in hopper 60 placed below exit face 28. The autogranulating process efficiently forms highly filled granules in a range of sizes, with a minimum of equipment and processing cost. Pelletizer 46 of FIG. 2 is also not required, and the granules 58 can be used in their autogranulated state without further processing.

Traditional pelletized molding compositions typically have very regular shapes and uniform sizes, for example cylindrical shapes or pillows that are approximately the same size from pellet to pellet. The autogranulated extrudate of the invention typically will be a blend of irregularly-shaped granules having a range of shapes and sizes, and will lack the uniform appearance of traditional pelletized molding compositions. Despite such non-uniform appearance, the autogranulated extrudate can provide an excellent molding composition, e.g., for compression molding highly filled conductive components having complex shapes such as fuel cell separators and endplates.

Suitable extruders are available from a variety of suppliers. If desired, extruders having more than two screws can be employed, e.g., three or four screw extruders. As will be appreciated by those skilled in the art, the screw configuration and extruder operating conditions may benefit from optimization or adjustment depending on the materials and equipment employed and the desired end use for the autogranulated extrudate. Representative extruders and extruder screws are shown in U.S. Pat. Nos. 4,875,847, 4,900,156, 4,911,558, 5,267,788, 5,499,870, 5,593,227, 5,597,235, 5,628,560 and 5,873,654.

A variety of thermoplastic resins can be employed in the invention. Suitable resins include polyphenylene sulfides, polyphenylene oxides, liquid crystal polymers, polyamides, polycarbonates, polyesters, polyvinylidene fluorides and polyolefins such as polyethylene or polypropylene. Other suitable resins are listed in the above-mentioned references or described in publications such as “High Performance Plastics from Ticona Improve Fuel Cell Systems” (Ticona division of Celanese AG). Representative commercially available polyphenylene sulfides include those available from the Ticona division of Celanese AG under the trademark FORTRON and those available from Chevron Phillips Chemical Company LP under the trademark RYTON. Representative commercially available polyphenylene oxides include those available from GE Plastics under the trademark NORYL. Representative liquid crystal polymers include those available from the Ticona division of Celanese AG under the trademark VECTRA, those available from Amoco Performance Products, Inc. under the trademark XYDAR and those available from E. I. duPont de Nemours and Company under the trademark ZENITE. Liquid crystal polymers are particularly preferred. The resin can be employed in a neat (viz., unfilled) form (e.g., VECTRA A950 liquid crystal polymer) or in a form that already includes one or more fillers (e.g., VECTRA A230 30% carbon fiber reinforced liquid crystal polymer and VECTRA A625 25% graphite filled liquid crystal polymer). Recycled autogranulated extrudate (and if desired, recycled and reground molded products made from such extrudate) can be added in suitable amounts to the thermoplastic resin.

A variety of fillers can be employed in the invention, in a variety of forms including particles, flakes, fibers and combinations thereof. Conductive fillers are especially preferred, including carbon (e.g., graphite, carbon black, carbon nanofibers and carbon nanotubes), metals (e.g., titanium, gold and niobium), metal carbides (e.g., titanium carbide), metal nitrides (e.g., titanium nitride and chromium nitride) and metal-coated particles, flakes or fibers (e.g., nickel-coated graphite fibers). Graphite is a particularly preferred conductive filler. Suitable nonconductive fillers include silica, calcium carbonate, magnesium carbonate, aluminum hydroxide, magnesium hydroxide, alumina, zinc oxide, clay, talc, glass powder, glass microbubbles, barium sulfate, plastic beads (e.g., polyester or polystyrene beads), olefin-based fibers (e.g., polyethylene fibers and polypropylene fibers), aramid fibers (e.g., NOMEX™ or KEVLAR™ fibers), rock wool, glass flakes and mica. The filler can have a variety of sizes (e.g., particle diameters, fiber lengths, or fiber length/diameter ratios) and a variety of surface areas. For example, when graphite particles are employed in the invention they preferably have a particle diameter of about 0.1 to about 200 micrometers, more preferably about 0.1 to about 25 micrometers, and a surface area of about 1 to about 100 m²/g, more preferably about 1 to about 10 m²/g as measured using the BET method. Carbon black particles preferably have a particle size less than about one micrometer and a surface area greater than about 500 m2/g. Carbon nanofibers and carbon nanotubes preferably have diameters ranging from a few nanometers to several hundred nanometers, and aspect ratios ranging from about 50 to about 1,500.

The autogranulated extrudate can contain very high filler loading levels. Loading levels of at least 40 wt. % filler are preferred, and loading levels of 50 to 95 wt. %, 60 to 95 wt. %, 70 to 95 wt. % or 80 to 95 wt. % filler are more preferred. The filler level should not be so low that autogranulation of the extrudate does not occur, and should not be so high so that the extrudate can not be compression molded using conventional molding equipment and a temperature of 300° C. or less into a self-supporting unitary article. At higher loading levels the extrudate is not readily pelletizable, that is, its rheological behavior is such that the extrudate can not be extruded through a strand die and chopped into pellets using conventional filled thermoplastic resin pelletizing equipment. The autogranulated extrudate typically contains a blend of granules whose average particle diameter may range from about 40 to about 4000 micrometers. The blend can have a unimodal or polymodal (e.g., bimodal) particle size distribution. It generally will not be necessary to screen or otherwise classify the extrudate, and it can be molded as is without removal of fine particles from the blend. The ability to use the extrudate without screening is especially desirable for compression molding. If desired, autogranulated extrudates containing differing weight fractions of filler can be combined with one another, e.g., by dry mixing.

The thermoplastic composite granules may contain other adjuvants such as dyes, pigments, indicators, light stabilizers and fire or flame retardants. The types and amounts of such adjuvants will be familiar to those skilled in the art.

The thermoplastic composite granules typically will be molded or otherwise subjected to further processing after they exit the extruder. The granules are especially suited for compression or injection molding. Suitable molding equipment and conditions will be familiar to those skilled and the art. The resulting molded or otherwise processed articles have a wide variety of uses, including fuel cell separator plates and end plates, battery electrodes, medical device electrodes, electromagnetic radiation absorbing materials, thermally or electrically conductive shields, trays and heat sinks. As will be appreciated by those skilled in the art, the final processed article can have a solid, hollow, foamed or other suitable configuration, contingent upon attainment of the desired level of surface or volume resistivity. For electrically conductive articles, volume resistivity values of about 0.1 ohm-cm or less, more preferably about 0.01 ohm-cm or less, are preferred, as evaluated using the four-point probe method described in Blythe, A. R., “Electrical Resistivity Measurements of Polymer Materials”, Polymer Testing 4, 195-200 (1984)).

The invention is further illustrated in the following illustrative examples, in which all parts and percentages are by weight unless otherwise indicated.

### EXAMPLE 1

Powdered polyphenylene sulfide resin (FORTRON™ 203B6, commercially available from the Ticona Division of Celanese AG) was twin-screw compounded with 70 wt. % No. 8920 graphite flakes (commercially available from Superior Graphite Co.) in a Model ZE40A twin screw extruder (commercially available from the Berstorff division of Krauss-Maffei Corp.), operated without an 8-0 adapter, pelletizing die or breaker plate. Upon exiting the extruder barrel, the extrudate spontaneously formed irregularly-shaped granules in a range of granule sizes. The individual granules were primarily flattened chunks having rounded and flattened portions, some surface striations and a shiny grey appearance. Despite the irregular size and appearance of the granules they were not subjected to pelletization, and were instead evaluated as a molding composition in their as-extruded form. The granules were compression molded using a heated laboratory press (commercially available from Carver, Inc.). The press was first brought to 300° C. at 34.5 Mpa. After reaching 300° C. the pressure was increased to 137.9 MPa and held at this pressure for 3 minutes to form the granules into a 102×102×3.2 mm flat rectangular plate. The resulting molded part had a uniform, low gloss matte appearance with fairly well-formed corners.

### COMPARISON EXAMPLE 1

The mixture of resin and graphite flakes employed in Example 1 was dry-blended rather than extruded. The resulting blend could not be molded into well-formed separation plates using the Carver laboratory press. Several additions of the blend interspersed with molding cycles were required to obtain dense molded parts. However, the parts delaminated when the mold was opened.

### COMPARISON EXAMPLE 2

The mixture of resin and graphite flakes employed in Example 1 was extruded through a reciprocating single screw extruder of an injection molding machine (150 Ton molding machine commercially available from Engel Machinery Inc.) equipped with a manifold and a 1.5 mm diameter die. The extrudate was formed during the injection cycle usually used during purging operations or when making an air shot. The extruded strands were manually chopped into pellets having a length of about 4 mm. The resulting pellets could not be molded into well-formed separation plates using the Carver laboratory press or using a larger heated compression press (commercially available from Hull Corp.) operated at 20 Mpa and a temperature of 300° C. The molded parts had poorly-formed corners whose “cottage cheese” appearance appeared to be due to projecting fragments of partly-fused pellets.

### EXAMPLE 2

Pellet form liquid crystalline polymer resin (VECTRA™ A950, commercially available from Ticona Division of Celanese AG) was added to the inlet end of the twin screw extruder employed in Example 1. No. 2937 G graphite flakes (commercially available from Superior Graphite Co.) were added to the extruder at the main feed port to provide a 70 wt. % graphite loading level in the extrudate. Upon exiting the extruder barrel, the extrudate spontaneously formed irregularly-shaped granules in a range of granule sizes. The individual granules were primarily flattened chunks having rounded and flattened portions, some surface striations and a shiny grey appearance. The granules had an average diameter of about 586 micrometers as determined using W. S. Tyler Sieve Trays of 4 to 400 mesh size. As further illustrated in FIG. 4, the granules ranged in size from about 45 micrometers to about 2000 micrometers, with the majority of the granules having a diameter between about 250 and about 2000 micrometers. Surface area measurements made using a single-point BET test and a model SA-6201 surface area analyzer (commercially available from Horiba Instruments Inc.) were performed for each size fraction shown in FIG. 4. The overall average surface area was 0.13 m²/g, well below the 50 m²/g surface area of the graphite flakes. The density of each size fraction shown in FIG. 4 ranged from 1.73 to 1.80 g/cc with an average of 1.78 g/cc, as determined using ASTM method D782-91. When evaluated in vacuum, the density ranged from 1.81 to 2.09 g/cc with an average of 1.84 g/cc. This suggests that the porosity of each fraction may vary significantly and may (depending on the forming process) affect electrical conductivity. Bulk density was also determined using an autotap attachment for the surface area analyzer. After 600 taps, the bulk density was 1.02 g/cc, indicating that the granules averaged about 45% porosity based on their 1.84 g/cc average density in vacuum.

Despite the irregular size and appearance of the granules they were not subjected to pelletization, and were instead evaluated as a molding composition in their as-extruded form. The granules were poured into a 100×100×2.5 mm flat rectangular plate mold. The granules were compression molded using the Hull Press employed in Comparison Example 2 at a temperature of 300° C. and a pressure of 20 MPa. The resulting molded part had a uniform, low gloss matte appearance with well-formed sharp-edged corners. Using the above-mentioned four point probe test, the average volume resistivity of the molded part was determined to be about 0.274 ohm-cm

### EXAMPLES 3-4

Using the method and materials of Example 1, thermoplastic composite granules containing 80 wt. % or 90 wt. % filler were prepared and compression molded to form fuel cell separator plates. The plates exhibited four point probe test average volume resistivity values of 0.0996 or 0.02094 ohm-cm, respectively. These values represent very low resistivity.

### EXAMPLES 5-11 AND COMPARISON EXAMPLE 3

Using the method of Example 1, thermoplastic composite granules were prepared using a XYDAR™ liquid crystal polymer (commercially available from Amoco Performance Products, Inc.) and the graphite flakes employed in Example 1. The density of the liquid crystal polymer resin was 1.38 g/cm³ and the density of the graphite flake filler was 2.25 g/cm³. Set out below in Table I are the Example No., weight percent filler, weight percent resin, calculated extrudate density, calculated volume percent filler, calculated volume percent resin, and extrudate appearance and moldability.

TABLE I

| | Wt. | | Extrudate | | | | |
|---|---|---|---|---|---|---|---|
| Example | % | Wt. % | Density | Vol % | Vol % | Extrudate | |
| No. | Filler | Binder | (g/cm³) | Filler | Binder | Appearance | Moldability |
| 5 | 40% | 60% | 1.63 | 29% | 71% | Elongated | Excellent |
| | | | | | | shards, ca. | |
| | | | | | | 4-12 mm | |
| 6 | 50% | 50% | 1.71 | 38% | 62% | Flattened | Excellent |
| | | | | | | chunks, ca. | |
| | | | | | | 1-5 mm | |
| 7 | 60% | 40% | 1.80 | 48% | 52% | Flattened | Excellent |
| | | | | | | chunks, ca. | |
| | | | | | | 1-4 mm | |
| 8 | 70% | 30% | 1.89 | 59% | 41% | Flattened | Excellent |
| | | | | | | chunks, ca. | |
| | | | | | | <1-4 mm | |
| 9 | 80% | 20% | 2.00 | 71% | 29% | Flattened | Excellent |
| | | | | | | chunks, ca. | |
| | | | | | | <1-3 mm | |
| 10 | 90% | 10% | 2.12 | 85% | 15% | Flattened | Excellent |
| | | | | | | chunks, ca. | |
| | | | | | | <1-2 mm | |
| 11 | 95% | 5% | 2.18 | 92% | 8% | Powder | Fair |
| | | | | | | <<1 mm | |
| Comp. 3 | 100% | 0% | 2.25 | 100% | 0% | Dust | Poor |

As shown in Table I, autogranulating extrudates could be formed at very high filler loading levels and molded into useful articles.

Various modifications and alterations of this invention will be apparent to those skilled in the art without departing from the scope and spirit of this invention. This invention should not be restricted to that which has been set forth herein only for illustrative purposes.

We claim:

1. A process for forming thermoplastic composite granules comprising extruding through a multiple screw extruder:
a. thermoplastic resin and
b. sufficient filler so that an autogranulating extrudate exits the extruder barrel.

2. A process according to claim 1 wherein the extruder is a twin screw extruder.

3. A process according to claim 1 wherein the extrudate is moldable.

4. A process according to claim 1 wherein the extrudate is not readily pelletizable.

5. A process according to claim 1 wherein the resin comprises polyphenylene sulfide, polyphenylene oxide, liquid crystal polymer, polyamide, polycarbonate, polyester, polyvinylidene fluoride or polyolefin.

6. A process according to claim 1 wherein the resin comprises liquid crystal polymer.

7. A process according to claim 1 wherein the filler comprises conductive particles.

8. A process according to claim 7 wherein the filler comprises carbon, metal, metal carbide, metal nitride, or metal-coated particles, flakes or fibers.

9. A process according to claim 7 wherein the filler comprises graphite.

10. A process according to claim 7 further comprising molding the extrudate to form a fuel cell separator or end plate.

11. A process according to claim 10 further comprising assembling a plurality of such separator plates separated by at least one membrane between plates to form a fuel cell.

12. A process according to claim 7 wherein the filler is about 40 to about 95 percent of the weight of the extrudate.

13. A process according to claim 7 wherein the filler is about 60 to about 95 percent of the weight of the extrudate.

14. A process according to claim 7 wherein the filler is about 80 to about 95 percent of the weight of the extrudate.

15. A process according to claim 1 wherein the filler comprises nonconductive particles.

16. An autogranulating thermoplastic composite comprising a blend of irregularly shaped granules containing thermoplastic resin and filler.

17. A thermoplastic composite according to claim 16 wherein the composite is moldable.

18. A thermoplastic composite according to claim 16 wherein the composite is not readily pelletizable.

19. A thermoplastic composite according to claim 16 wherein the resin comprises polyphenylene sulfide, polyphenylene oxide, liquid crystal polymer, polyamide, polycarbonate, polyester, polyvinylidene fluoride or polyolefin.

20. A thermoplastic composite according to claim 16 wherein the resin comprises liquid crystal polymer.

21. A thermoplastic composite according to claim 16 wherein the composite comprises flattened chunks having a diameter less than about 5 mm.

22. A thermoplastic composite according to claim 16 wherein the composite comprises flattened chunks having a diameter less than about 3 mm.

23. A thermoplastic composite according to claim 16 wherein the filler comprises conductive particles.

24. A thermoplastic composite according to claim 23 wherein the filler comprises carbon, metal, metal carbide, metal nitride, or metal-coated particles, flakes or fibers.

25. A thermoplastic composite according to claim 23 wherein the filler comprises graphite.

26. A thermoplastic composite according to claim 23 wherein the filler is about 40 to about 95 percent of the weight of the composite.

27. A thermoplastic composite according to claim 23 wherein the filler is about 60 to about 95 percent of the weight of the composite.

28. A thermoplastic composite according to claim 23 wherein the filler is about 80 to about 95 percent of the weight of the composite.

29. A thermoplastic composite according to claim 23 wherein a molded article formed by compression molding the composite has a volume resistivity of about 0.1 ohm-cm or less.

30. A thermoplastic composite according to claim 23 wherein a molded article formed by compression molding the composite has a volume resistivity of about 0.01 ohm-cm or less.

31. A thermoplastic composite according to claim 16 wherein the filler comprises nonconductive particles.
